(19) United States
(12) Patent Application Publication
(10) Pub. No.: US 2024/0192341 A1
(43) Pub. Date: Jun. 13, 2024

(54) METHOD FOR MONITORING AN ANGULAR POSITION OF A LIDAR SYSTEM

(71) Applicant: Robert Bosch GmbH, Stuttgart (DE)

(72) Inventor: Johannes Richter, Renningen (DE)

(21) Appl. No.: 18/554,549

(22) PCT Filed: Apr. 21, 2022
(86) PCT No.: PCT/EP2022/060499

§ 371 Date: Oct. 9, 2023

(30) Foreign Application Priority Data
Apr. 30, 2021 (DE) 10 2021 204 330.5

(51) Int. Cl. G01S 7/497

(52) U.S. Cl. CPC G01S 7/4972

(57) ABSTRACT

A method for monitoring an angular position of a LiDAR system having at least one rotatable mirror. The method includes: a) emitting laser light by means of the LiDAR system; b) receiving laser light by means of the LiDAR system; c) determining the angular position of the LiDAR system on the basis of the received laser light; d) monitoring the angular position by comparing a predefined angular position with the angular position determined in step c). A corresponding LiDAR system, a computer program, and a machine-readable storage medium are also described.

### FIELD

The present invention relates to a method for monitoring an angular position of a LiDAR system.

### BACKGROUND INFORMATION

Highly and fully automated vehicles (levels 3-5) will be more and more common on our roads in the coming years. There are various concepts as to how such an automated vehicle can be realized. All of these approaches require a wide variety of sensors (e.g., video cameras, LiDAR, radar, ultrasonic sensors), wherein in particular LiDAR sensors, which are optical sensors that use laser light to create 3D point clouds of the environment, play an increasingly important role.

One type of LiDAR sensor is the rotating mirror LiDAR sensor. In the case of the rotating mirror LiDAR sensor, the transmitting and receiving modules are permanently installed on the stator and the laser light is deflected in different spatial directions by a rotating mirror. The mirror rotation covers one spatial direction, while the second scanning direction is covered by applying a plurality of laser sources or by using a line flash and a plurality of detectors in the receiving module.

The precise measurement directions of the laser radiation depend on the rotor position and are determined in a calibration step during the manufacture of the LiDAR sensor (angle calibration). During normal operation, the current rotor angle is determined by an encoder. However, the determination of the angle of the rotating mirror may become erroneous over time. In such cases, the angles must be recalibrated or reset. It may be of high safety relevance that the automated vehicle automatically recognizes such a miscalibration situation and requests a recalibration accordingly. However, visiting a repair shop for recalibration is expensive. Therefore, it would be desirable to develop a method to automatically recalibrate LiDAR sensors while in use on the road (also called online calibration).

U.S. Patent Application Publication No. US 2019/339368 A1 describes a LiDAR system in which a reference surface is used for calibration.

U.S. Patent Application Publication No. US 2019/383918 A1 describes a LiDAR system that can detect an error in the angular orientation between different prisms.

### SUMMARY

The present invention provides a method for monitoring an angular position of a LiDAR system having at least one rotatable mirror.

According to an example embodiment of the present invention, in this case, laser light is emitted by the LiDAR system and at least partially received again by the LiDAR system. This is caused, for example, by reflection from an object.

The angular position of the LiDAR system is subsequently determined on the basis of the received laser light.

Furthermore, the angular position of the LiDAR system is monitored by comparing the determined angular position with a predefined angular position.

This is advantageous because accurate knowledge of the angular position is required to be able to accurately place objects detected by the LiDAR system in the environment. An excessive angular deviation would thus lead to inaccurate localization of the detected objects, which could be important to safety in particular in the case of downstream functions, for example for autonomous driving. Using the method according to the present invention, a correct angular position is also ensured during operation, because, in the event of excessive deviations, a calibration can be carried out, for example, and thus no safety-critical situations can occur.

Further advantageous embodiments of the present invention are disclosed herein.

According to an example embodiment of the present invention, the angular position is expediently determined on the basis of the measured intensity of the received laser light and/or of the time interval between the emission of the laser light and the reception of the laser light. This is advantageous, for example, for using reflections from a cover glass of the LiDAR system for monitoring, for example, in that the time interval has to be correspondingly short.

According to an example embodiment of the present invention, expediently, a maximum intensity of the received laser light is used to determine the angular position of the LiDAR system. This can be done, for example, by means of a comparison with a predefined maximum intensity. If the intensity of the received laser light exceeds the predefined maximum intensity, this means that a correspondingly predefined angular position is present. This is advantageous because a maximum intensity can be reliably detected.

According to an example embodiment of the present invention, expediently, the angular position corresponds to a rotational position of the at least one rotatable mirror. This is advantageous because the rotatable mirror can thus be directly monitored and a malfunction can be detected.

The aforementioned method steps are expediently carried out iteratively or continuously, until, for example, a vehicle in which the LiDAR system is integrated has been switched off. Thus, permanent monitoring of the angular position of the LiDAR system is possible.

According to an example embodiment of the present invention, expediently, the angular position is calibrated when a predefined deviation between the determined and predefined angular position is exceeded. This is advantageous for ensuring a correct and reliable operation of the LiDAR system.

The determined deviation is expediently added to the previously determined angular positions for calibration. This is advantageous for obtaining correct angular positions.

According to an example embodiment of the present invention, expediently, the power of the emitted laser light is adapted on the basis of the measured intensity of the received laser light. This is advantageous for ensuring that eye safety is guaranteed by the LiDAR system. For example, if a predefined intensity limit value is exceeded, the emitted laser power can be reduced accordingly.

Furthermore, the present invention provides a LiDAR system comprising at least one rotatable mirror, a laser for emitting laser light, a detector for detecting laser light and an electronic control unit, which are designed to carry out the steps of the method according to the present invention.

Furthermore, the present invention provides a computer program comprising commands that cause the aforementioned LiDAR system to perform all of the steps of the method according to the present invention.

Furthermore, the present invention provides a machine-readable storage medium on which the computer program according to the present invention is stored.

### DETAILED DESCRIPTION OF EXAMPLE EMBODIMENTS

Advantageous embodiments of the present invention are illustrated in the figures and explained in more detail in the following description.

FIG. 1 shows a flow chart of the method according to the present invention according to a first example embodiment.

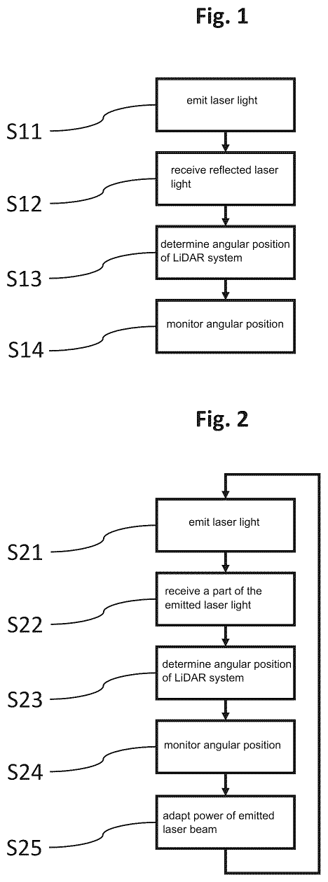

FIG. 2 shows a flow chart of the method according to the present invention according to a second example embodiment.

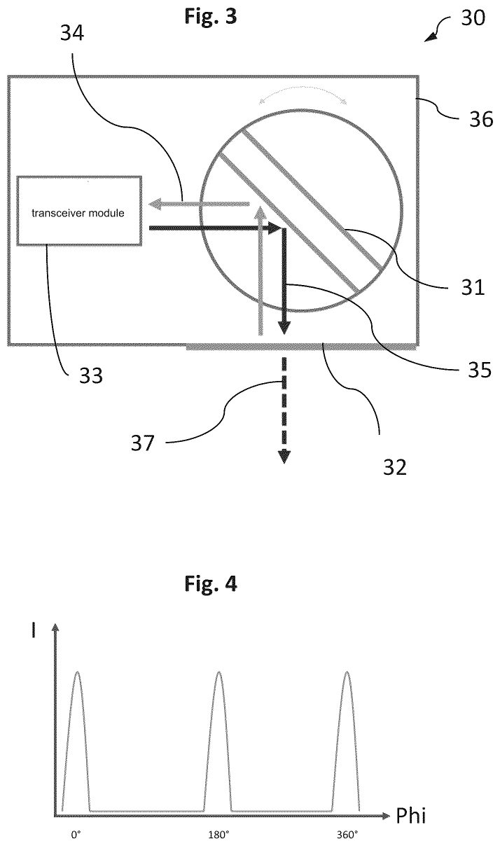

FIG. 3 shows a schematic view of a LiDAR system according to the present invention according to one example embodiment.

FIG. 4 shows a schematic view of an expected profile of the intensity of the back reflection from the cover glass over the rotor angle for the LiDAR system according to FIG. 3.

### DETAILED DESCRIPTION OF EXAMPLE EMBODIMENTS

In the figures, identical reference signs refer to identical device components or identical method steps.

FIG. 1 shows a flow chart of the method according to the present invention according to a first example embodiment. In this case, laser light is emitted by the LiDAR system in a first step S11. In a second step S12, at least a part of the emitted laser light, which was reflected in particular by a cover glass of the LiDAR system, is received again by the LiDAR system. In a third step S13, the angular position of the LiDAR system is determined on the basis of the received laser light. This is possible because, for example, the laser light reflected from a cover glass of the LiDAR system can only be received by the LiDAR system under certain angular positions; see also FIG. 3. The angle can then be deduced from the knowledge of a maximum intensity. In a fourth step S14, the angular position is monitored by comparing a predefined angular position with the determined angular position. If deviations occur that exceed a predefined extent, a message can, for example, be displayed that a workshop visit is required. Alternatively, the angular position can also be calibrated using the determined angular position.

FIG. 2 shows a flow chart of the method according to the present invention according to a second example embodiment. In this case, laser light is emitted by the LiDAR system in a first step S21. This can be done, for example, by means of a laser installed in the LiDAR system.

In a second step S22, at least a part of the emitted laser light is received by the LiDAR system, i.e., detected, for example, by a detector in the LiDAR system.

In a third step S23, the angular position of the LiDAR system is determined on the basis of the received laser light. This can be done, for example, on the basis of the intensity of the received laser light received, i.e., measured, in the second step S22. Furthermore, the angular position can be determined on the basis of the time interval between the emission and the reception of the laser light. Thus, it is possible to take into account the fact that a reflection within the LiDAR system, for example from a cover glass, impinges on the detector within a very short period of time. Thus, the relationship between emitted and received light can be established.

In a fourth step S24, the angular position is monitored by comparing a predefined angular position with the angular position determined in the third step S23. This is advantageous for detecting deviations in good time. Accordingly, the calibration step described above can then be optionally initiated.

Here, in a fifth step S25, the power of the emitted laser beam is adapted on the basis of the measured intensity of the received laser light. Subsequently, the first step S21 is continued and the laser beam is emitted with the correspondingly adapted power.

FIG. 3 is a schematic view of a LiDAR system 30 according to the present invention according to one embodiment. The LiDAR system 30 comprises a housing 36 and a combined transceiver module 33. The module 33 comprises a laser for emitting laser light, a receiver for receiving laser light and an electronic control unit. These units can also be integrated separately into the LiDAR system 30.

Furthermore, the LiDAR system 30 comprises a rotatable double mirror 31. On one side, the housing 36 has a transparent cover glass 32 through which the laser light 35 can at least partially leave the housing 36 of the LiDAR system 30. This results in the laser light 37 outside the LiDAR system 30. A part 34 of the laser light 35 is reflected from the cover glass 32 and detected by the receiver integrated in the combined transceiver module 33. The position of the mirror 31 shown here results in a maximum intensity for the reflected part 34 of the laser light 35, as is shown in FIG. 4. This position can be identified, for example, with a 0° position.

FIG. 4 shows a schematic illustration of an expected profile of the intensity I of the back reflection from the cover glass over the rotor angle Phi for the LiDAR system according to FIG. 3. Because of the double mirror, an intensity maximum occurs in 180° increments, which can be used to monitor and optionally calibrate the angular position.

1-11. (canceled)

12. A method for monitoring an angular position of a LiDAR system having at least one rotatable mirror, the method comprising the following steps:
a) emitting laser light using the LiDAR system;
b) receiving laser light using the LiDAR system;
c) determining the angular position of the LiDAR system based on the received laser light; and
d) monitoring the angular position by comparing a predefined angular position with the angular position determined in step c).

13. The method according to claim 12, wherein step c) is performed based on: i) a measured intensity of the received laser light, and/or ii) a time interval between the emission of the laser light and the reception of the laser light.

14. The method according to claim 12, wherein a maximum intensity of the received laser light is used to determine the angular position of the LiDAR system in step c).

15. The method according to claim 12, wherein the angular position corresponds to a rotational position of the at least one rotatable mirror.

16. The method according to claim 12, wherein the method steps are carried out iteratively.

17. The method according to claim 12, wherein the angular position is calibrated when a predefined deviation between the determined angular position and the predefined angular position is exceeded.

18. The method according to claim 12, wherein a determined deviation is added to the previously determined angular positions for calibration.

19. The method according to claim 12, wherein a power of the emitted laser light is adapted based on a measured intensity of the received laser light.

20. A LiDAR system, comprising:
at least one rotatable mirror;
a laser configured to emit laser light;
a receiver configured to receive laser light; and
an electronic control unit configured to monitor an angular position of the LiDAR system, the electronic control unit configured to:
a) emit laser light using the LiDAR system;
b) receive laser light using the LiDAR system;
c) determine the angular position of the LiDAR system based on the received laser light; and
d) monitor the angular position by comparing a predefined angular position with the angular position determined in step c).

21. A non-transitory machine-readable storage medium on which is stored a computer program for monitoring an angular position of a LiDAR system having at least one rotatable mirror, the computer program, when executed by a processor, causing the processor to perform the following steps:
a) emitting laser light using the LiDAR system;
b) receiving laser light using the LiDAR system;
c) determining the angular position of the LiDAR system based on the received laser light; and
d) monitoring the angular position by comparing a predefined angular position with the angular position determined in step c).
